(19) United States
(12) Patent Application Publication
(10) Pub. No.: US 2014/0327173 A1
(43) Pub. Date: Nov. 6, 2014

(54) REDUCING CROWN FLASH IN INJECTION-MOLDING PROCESSES

(71) Applicants: Edward Joseph JENKO, Essex, VT (US); Abdeslam BOUTI, St. Albans, VT (US); Husky Injection Molding Systems Ltd., Bolton (CA)

(72) Inventors: Edward Joseph Jenko, Essex, VT (US); Abdeslam Bouti, St. Albans, VT (US)

(73) Assignee: Husky Molding Systems Ltd. a corporation

(21) Appl. No.: 14/357,775

(22) PCT Filed: Nov. 14, 2012
(86) PCT No.: PCT/US2012/064904

§ 371 Date: May 13, 2014

Related U.S. Application Data
(60) Provisional application No. 61/559,915, filed on Nov. 15, 2011.

(51) Int. Cl. B29C 45/38

(52) U.S. Cl. CPC B29C 45/38; B29C 2045/384
USPC 264/161; 425/562

(57) ABSTRACT

Crown-flash-reduction systems, methods, and apparatuses for actively reducing the likelihood of formation of crown flash on injection-molded objects. The active reduction includes moving at least one of a valve member and a mold gate periphery in a manner that actively weakens or separates molding material present in a molded object from molding material present in the closed mold gate prior to or in conjunction with de-molding the molded object.

### TECHNICAL FIELD

The present invention generally relates to the field of injection molding. In particular, the present invention is directed to reducing crown flash in injection-molding processes.

### BACKGROUND OF THE INVENTION

There are persistent issues in the hot runner industry when using a plunger-type valve stem. There is a necessary space between the cylindrical portion of the stem end and the cavity gate diameter. As built the space is typically quite close (20 microns or less) and therefore the surface is normally made using a high precision machine resulting in a very smooth surface finish, approaching the finish of a polished surface. Because the molten plastic in the gate diameter is displaced by the motion of the stem coming into the cavity, plastic is wedged in the gap between the stem's cylindrical end and the gate diameter. When the molded part is sufficiently cooled to permit de-molding, the plastic in the stem/gate gap can tend to be “pulled” out of the gap by the molded article and results in a witness ring, often referred to as a “crown” or “crown flash.” FIG. 1 illustrates crown flash 10 present on a molded article 14 at the location of the gate (not shown) through which the molding material comprising the article flows into the mold cavity to form the article. Skilled artisans will be familiar with crown flash and the persistence of the problem of crown flash.

### SUMMARY OF THE INVENTION

In one implementation, the present disclosure is directed to an injection-molding system. The injection molding system includes a mold that includes a mold cavity and a gate in fluid communication with the mold cavity, the mold designed and configured for molding a molding and the gate having a periphery; a runner operatively configured for injecting a molding material into the mold cavity via the gate, the runner including a valve member operable to close the gate to flow of the molding material by movement of the valve member into the gate; and a crown-flash-reduction system designed and configured to actively participate in separating molding material present in the molding from molding material present between the valve member and the periphery of the gate when the valve member is positioned in the gate.

In another implementation, the present disclosure is directed to an injection-molding apparatus configured for injecting a molding material into a mold cavity via a mold gate having a periphery. The injection-molding apparatus includes a valve assembly comprising a valve member that is designed and configured to, during molding operations: reciprocate in a first motion between 1) an open position in which the gate is open to flow of the molding material and 2) a closed position in which the valve member extends into the gate so as to effectively close the mold gate to the flow of the molding material; and while the valve member is in the closed position, move in a second motion that is different from the first motion and is selected to participate in separating molding material in the mold cavity from molding material present between the valve member and the periphery of the mold gate.

In still another implementation, the present disclosure is directed to a method of injection molding a molding. The method includes injecting a molding material into a mold cavity via a gate so as to form the molding, wherein the gate has a periphery; positioning a valve member in the gate in a manner that substantially closes the gate to flow of the molding material into the mold cavity; and weakening or separating connection between molding material present in the molding from molding material present between the valve member and the periphery of the gate so as to limit formation of crown flash during de-molding of the molded part.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a photograph of crown flash present on a molded article at the location of a mold gate;

FIG. 2 is a diagrammatic view of an injection molding system made in accordance with aspects of the present invention;

FIG. 3 is a flow diagram illustrating a method of making an injection molding using active crown-flash reduction;

FIG. 4A is a cross-sectional partial view of a hot runner and mold, illustrating an exemplary crown-flash-reduction (CFR) system;

FIG. 4B is an enlarged cross-sectional view of the mold gate region of FIG. 4A with the valve stem in an open position;

FIG. 4C is an enlarged cross-sectional view of the mold gate region of FIG. 4A with the valve stem in a closed position;

FIG. 4D is a further-enlarged cross-sectional view of the mold gate region of FIG. 4A with the valve stem in the closed position;

FIG. 4E is a section taken along line 4E-4E of FIG. 4D, showing mechanical interlock features on the tip of the valve stem;

FIG. 4F is an enlarged cross-sectional view of the mold gate region of FIG. 4A during de-molding of the molding;

FIG. 5A is a cross-sectional partial view of a mold and a hot runner, illustrating an alternative CFR system made in accordance with the present invention;

FIG. 5B is an enlarged section taken along line 5B-5B of FIG. 5A, showing mechanical interlock features on the periphery of the gate; and

FIG. 6 is a cross-sectional partial view of components of yet another embodiment of a CFR system made in accordance with the present invention.

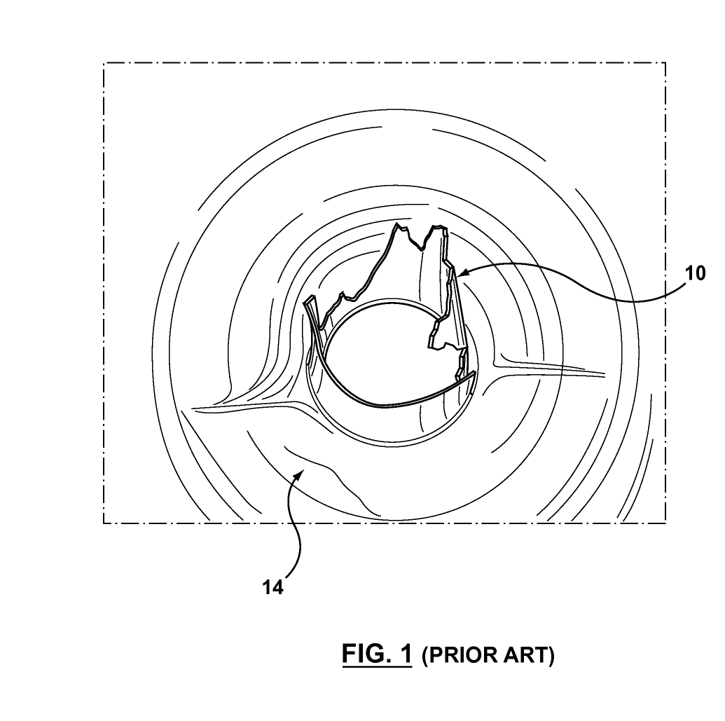

### DETAILED DESCRIPTION OF THE PREFERRED EMBODIMENT(S)

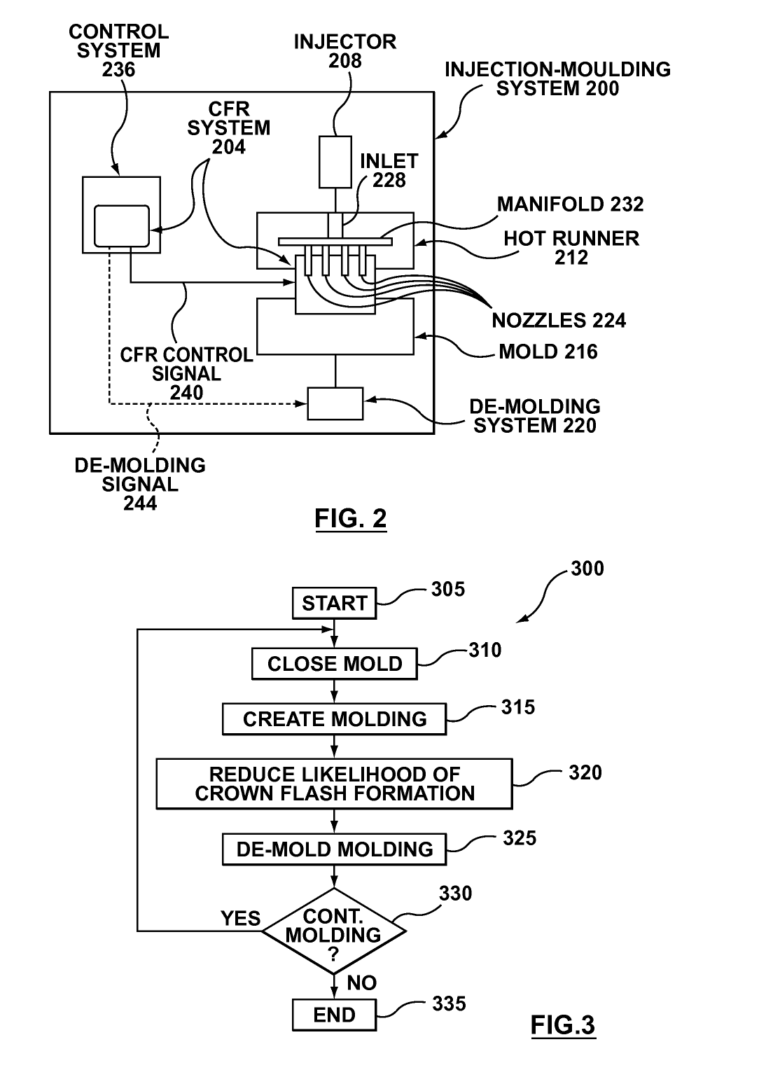

Referring again to drawings, FIG. 2 illustrates an exemplary injection-molding system 200 that includes a crown-flash-reduction (CFR) system 204 that is designed and configured to actively participate in reducing the amount of crown-flash that forms on injection-molded objects as compared to similarly configured injection-molding systems (not shown) not having such a CFR system. After reading this entire disclosure, those skilled in the art will understand the operation of CFR system 204 and the beneficial effects of utilizing such a system. Depending on the design of CFR system 204, crown flash can not only be reduced, but in some cases virtually entirely eliminated. Consequently, as used herein and in the appended claims the term “reduce,” “reducing,” “reduction,” and similar terms used in connection with “crown flash” includes not only reduction but also elimination. Benefits of reducing crown flash include reducing the amount of post-molding processing of molded items and creating aesthetically pleasing molded items with reduced need for post-molding processing.

In addition, it is noted that the term “crown flash” is used herein and in the appended claims to encompass flash present on molded objects as a result of molding material present in a mold gate in the generally annular region surrounding the tip portion of a valve stem when the tip portion is in the gate staying with the molded object after the object has been de-molded, regardless of the actual shape of the flash. For example, if the tip portion of the valve stem is off center within the gate, the flash may indeed not take on an actual crown shape as it can when the tip portion is centered. As another example, when the tip portion of the valve stem is cylindrical but the gate is worn to a non-circular shape, the flash may also not actually form a crown shape. Regardless, the flashes in these situations are still referred to herein and in the appended claims as “crown flash.”

As seen in FIG. 2, in addition to CFR system 204, exemplary injection-molding system 200 includes one or more injectors 208, a hot runner 212, a mold 216, and a de-molding system 220 (also sometimes referred to as an ejection system). Although those skilled in the art will understand the conventional functionalities of components 208, 212, 216, and 220 of injection-molding system 200, for the sake of completeness these components are briefly reviewed below before addressing CFR system 204 in more detail and before describing several specific examples of CFR systems.

Each injector 208 is designed and configured to inject a molding material (not shown), such as a plastic resin, into hot runner 212, which, in turn, delivers that material to mold 216, which contains one or more mold cavities (not shown) that is/are configured to produce a particular molding (not shown). As used herein and in the appended claims, the term “molding” means the sum of all molding material present in the mold cavity(ies) after injection of the molding material(s), regardless of whether the cavity(ies) define a single molded object or multiple molded object, with or without any other molded structures, such as cold runners joining multiple objects together within a single mold. When the molding material used in a particular injector 208 is a material that requires melting prior to injection, such as a thermoplastic resin, the corresponding injector may include an appropriate heating system (not shown) for keeping that material at an appropriate temperature for injection. Injectors are well known in the field of injection molding and need no further description herein for those skilled in the art to make and use the present invention to its fullest scope.

Hot runner 212 includes a plurality of nozzles 224, an inlet 228, and a manifold 232 that distributes the molding material to the nozzles. As will be described below in connection with detailed examples of various CFR systems made in accordance with the present invention, nozzles 224 include valve members (not shown) that are designed in conjunction with gates (not shown) to form valves that are alternatingly opened and closed at appropriate times to control the flow of the molding material(s) into mold 216. Not shown, but typically included in a hot runner are various components of support systems, such as a manifold heating system for keeping the molding material in manifold 232 at the proper temperature, a nozzle heating system for keeping the molding material in nozzles 224 at an appropriate temperature, and valve actuators for opening and closing the valves formed between hot runner 212 and mold 216, among others. Hot runners are well known in the field of injection molding and need no further description herein for those skilled in the art to make and use the present invention to its fullest scope.

De-molding system 220 is designed and configured to de-mold the molding from mold 216. De-molding system 220 can range from mold-opening systems for moldings that are susceptible to de-molding under mold-opening conditions to active systems, such as positive-pressure pneumatic, hydraulic or electric ejection systems, that act to force moldings out of mold 216. De-molding systems are well known in the field of injection molding and need no further description herein for those skilled in the art to make and use the present invention to its fullest scope.

As will be seen from some specific embodiments presented below, CFR system 204 actively participates in the reduction of crown flash in any of a number of ways. As will be seen, parts of hot runner 212 and mold 216 cooperate with one another to reduce crown flash. This is why crown-flash reduction system 204 is shown overlapping both hot runner 212 and mold 216. As will also be seen from those embodiments, a CFR system made in accordance with the present invention, such as CFR system 204, involves at least one moving part of either the hot runner or the mold, or both, the movement of which in some embodiments at least weakens the molding material proximate to the molding immediately adjacent to each gate and in other embodiments causes a complete separation of molding material in the molding from molding material located in the gate when the gate is closed.

Injection-molding system 200 may also include a control system 236 that controls the overall operation of injection-molding system. In addition to conventional functionality, control system 236 is designed and configured to generate a CFR signal 240 that causes CFR system 204 to operate at an appropriate time in the molding cycle to weaken or separate molding material proximate the mold gate in a manner that reduces the likelihood of crown flash formation. When CFR system 204 acts independently from de-molding system 220, for example, when the CFR system alone creates a complete separation of the molding material, control system 236 may generate CFR signal 240 sufficiently in advance of generating a separate de-molding signal 244 to allow the CFR system to complete the separation. In other embodiments, CFR system 204 can work in conjunction with de-molding system 220 to complete a separation of molding material. For example, when CFR system 204 weakens the molding material to a point sufficient that the de-molding operation effects complete separation, control system 236 may generate CFR signal 240 sufficiently in advance of generating a separate de-molding signal 244 to allow the CFR system to complete the weakening process.

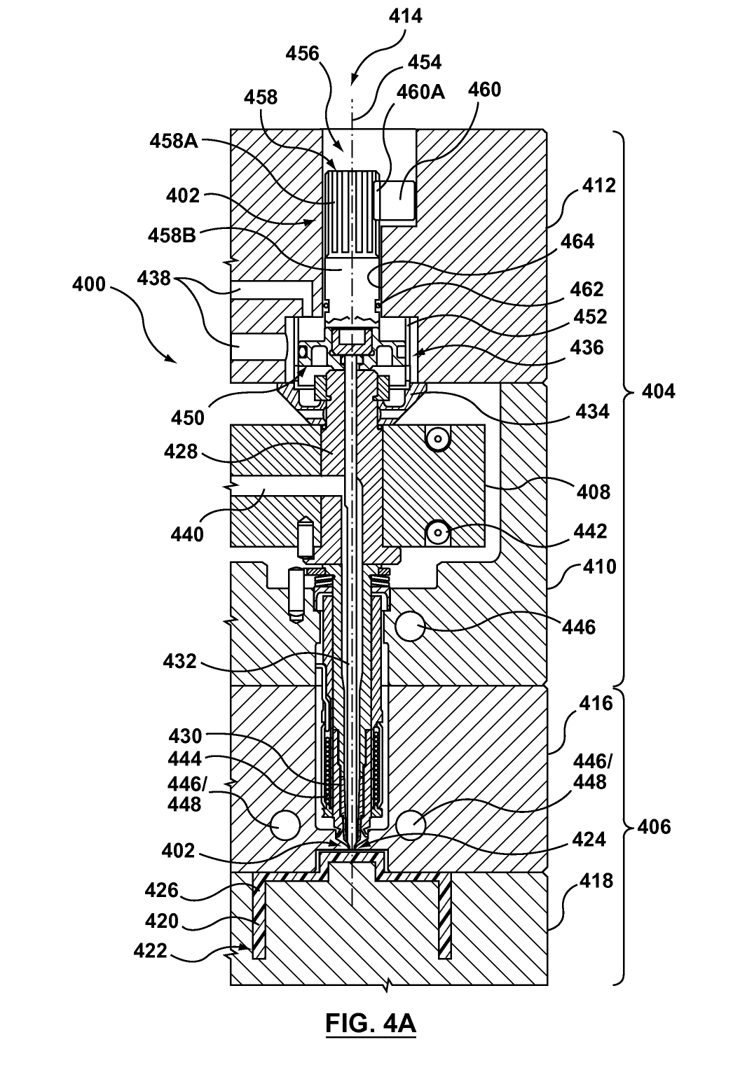

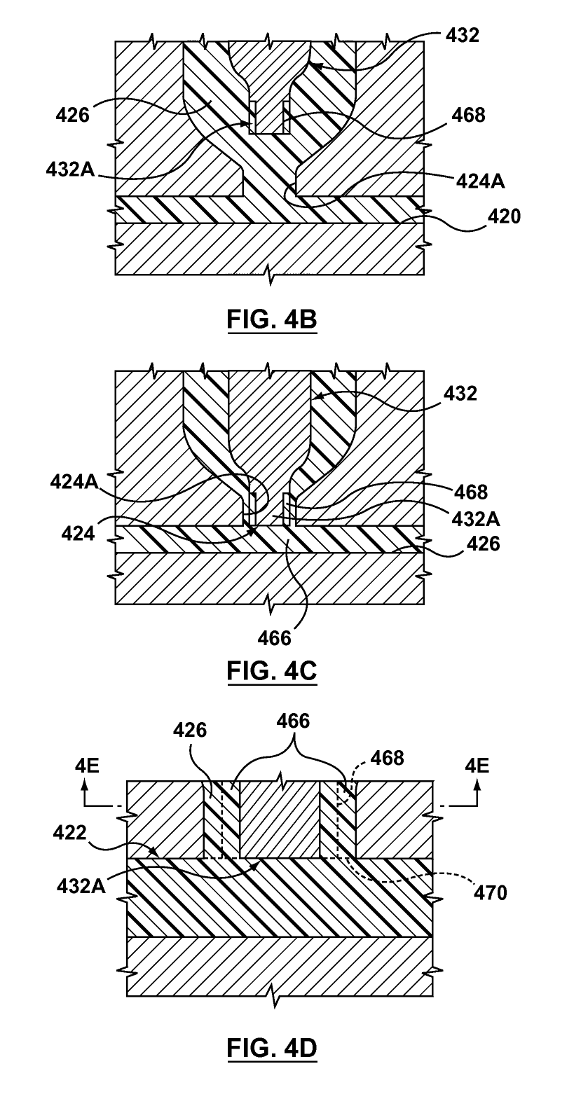

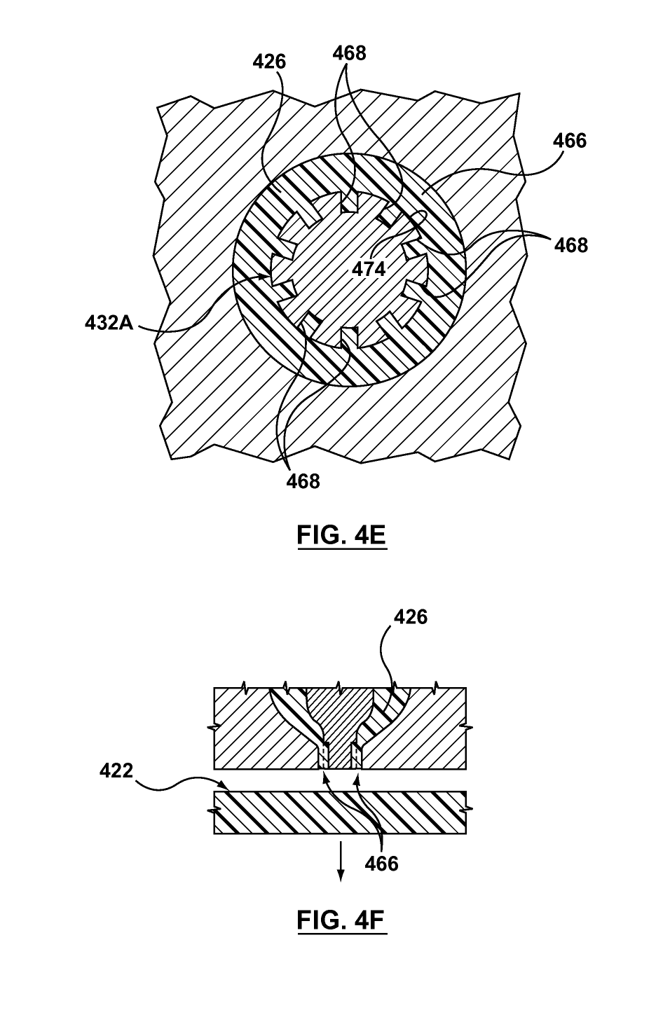

FIG. 3 illustrates a typical method 300 of making injection moldings using an injection-molding system made in accordance with the present invention. For convenience of illustration, method 300 is described in conjunction with injection-molding system 200 of FIG. 2. Referring now to FIG. 3 and also to FIG. 2 for contextual references, method 300 begins at step 305 where it is assumed that mold 216 is open. At step 310, mold 216 is closed and injection-molding system 200 is readied for a molding cycle. At step 315, a molding is created by injector 208 injecting a molding material into the cavity(ies) of mold 216. As those skilled in the art will understand, step 315 may include sub-steps such as opening one or more gate valves, packing the cavity as earlier-injected molding material cools, and closing the one or more gate valves. At step 320, the likelihood of formation of crown flash is actively reduced. As mentioned, activity that occurs at step 320 can range from at least weakening molding material in the region of each gate prior to de-molding to completely separating molding material in that region. FIGS. 4A to 4F, 5A, 5B, and 6 illustrate some exemplary structures for executing step 320. At step 325, the molding is de-molded from mold 216. At step 330, it is determined whether or not to perform another molding cycle. If so, method 300 proceeds back to step 310 at which mold 216 is closed and injection-molding system 200 is readied for another molding cycle. Then, steps 315, 320, 325, and 330 are repeated. If at step 330 it is determined that another molding cycle will not be performed, method 300 proceeds to step 335 at which the method is ended.

Turning now to some specific embodiments of CFR systems, FIG. 4A illustrates a hot runner/mold assembly 400 that incorporates a valve-stem-based CFR system 402. Assembly 400 includes a hot runner 404 and a mold 406. In this example, hot runner 404 includes a manifold 408, a manifold plate 410, a backing plate 412, and a plurality of valve assemblies 414, only one of which is shown for convenience. Manifold 408, manifold plate 410, and backing plate 412 can be of any conventional or other suitable design known in the art and, therefore, are not described in further detail herein. Mold 406 includes first and second plates 416 and 418, respectively, that define a mold cavity 420 shaped according to the molding 422 that is created during the injection-molding process. First plate 416 of mold 406 includes a gate 424 through which a molding material 426 is injected into cavity 420 to form molding 422.

Each valve assembly 414 includes, among other things, a manifold bushing 428, a nozzle tip 430, a valve stem 432, a backup pad 434, and an actuator 436 that, in this example, is actuated pneumatically via air inlets 438. Manifold 408 and valve assembly 414 define corresponding respective portions of a flow channel 440 that delivers molding material 426 from an injector (not shown) to nozzle tip 430 and, ultimately, into cavity 420 of mold 406. When molding material 426 needs to be kept in a molten state, manifold 408 and valve assembly 414 may have corresponding respective heaters 442 and 444 for keeping the molding material at an appropriate temperature within flow channel 440. Correspondingly, if molding material 426 needs to be cooled, mold 406 and/or hot runner 404 can include cooling channels 446 for circulating an appropriate coolant 448.

As mentioned above, valve actuator 436 is a pneumatic actuator, and it includes a piston 450 and a cylinder 452 that cooperate in the usual way to move valve stem 432 along its longitudinal axis 454 in a reciprocating manner to alternatingly close and open gate 424 during molding operations. FIG. 4B illustrates valve stem 432 in its open position in which gate 424 is open to allow molding material 426 to flow into mold cavity 420, and FIG. 4C illustrates the valve stem in its closed position in which the gate is closed to effectively stop the flow of the molding material into the mold cavity.

Referring again to FIG. 4A, CFR system 402 of this embodiment at least partially functions by rotating valve stem 432 about longitudinal axis 454 at a predetermined time during a molding cycle, as described below in more detail. Consequently, valve assembly 414 further includes a rotation-actuation mechanism 456 operatively configured and coupled to valve stem 432 so as to rotate the valve stem about longitudinal axis 454. In this example, rotation-actuation mechanism 456 is adapted to piston/cylinder actuator 436 and includes an elongated piston head 458 fixedly attached to piston 450 and movable therewith during the reciprocating motion of the piston during opening and closing of gate 424. Piston head 458 has a gear-toothed pinion region 458A and a smooth region 458B. Pinion region 458A is designed to enmesh with a rack gear 460, which is actuated by a suitable actuation mechanism (not shown) such as a linear actuator or a rotational actuator suitably coupled to the rack gear. As those skilled in the art will readily understand, when rack gear 460 is moved in a direction into and/or out of the plane of FIG. 4A, the enmeshing of teeth 460A on the rack gear with teeth on toothed region 458A of piston head 458 causes the piston head and valve stem 432 to rotate in the corresponding direction(s) about longitudinal axis 454.

In this embodiment, piston head 458 includes an O-ring 462 that seals against a corresponding bore 464 in backing plate 412 of hot runner 404. The seal provided by O-ring 462 allows piston 450 and piston head 458 to reciprocate without cylinder 452 losing actuation air from the pneumatic source (not shown). Those skilled in the art will readily appreciate that the rack and pinion arrangement of CFR system 402 can readily be replaced by any suitable actuation system/mechanism that rotates valve stem 432 as needed for the CFR system to accomplish its task, which is described below in detail.

Examples of alternative systems/mechanisms include direct-drive motors, chain drives, belt drives, and any of a wide variety of gear drives that may or may not include rack gears, among others. In some embodiments, the drive systems/mechanisms can be configured to drive multiple valve stems on a hot runner simultaneously with one another.

Referring now to FIGS. 4B and 4C, gate 424 has a periphery 424A that conformally receives a tip portion 432A of valve stem 432 when the valve stem is in its closed position, as seen in FIG. 4C. Tip portion 432A is sized relative to periphery 424A of gate so as to provide a generally annular gap 466 between the two. During molding operations, and when valve stem 432 is in its closed position (FIG. 4C), annular gap is occupied by molding material 426. To bring effect to the rotation of valve stem 432 for the purpose of actively reducing the likelihood of crown-flash formation, tip portion 432A of the valve stem includes one or more interlock features 468 that provide a mechanical interlock between molding material 426 in annular gap 466 and the tip portion. When molding material 426 has sufficiently solidified, for example, by cooling, the mechanical interlock between interlock feature(s) 468 and the molding material in annular gap 466, allows the rotation of valve stem 432 to rotate the molding material in the annular gap. As seen in FIG. 4D, as tip portion 432 rotates molding material 426 in annular gap 466 is rotated, the stresses in the molding material generally along a planar annulus 470 immediately adjacent to molding 422 increase to the point that molding material is weakened or separated at the planar annulus.

As seen in FIG. 4E, interlock features 468 in this example are recesses, here rectangular grooves, formed in the lateral surface 474 of tip region 432A. In other embodiments, the interlock feature(s) can be different, such as grooves and recesses of other configurations, and surface roughening, among others. Considerations for designing interlock feature(s) include, but are not limited to, the width of annular gap 466, the physical properties of molding material 426, and the temperature of the molding material at the time of operation of CFR system 402 (FIG. 4A). FIG. 4F shows molding 422 being de-molded and particularly highlights the absence of crown flash where the molding was joined to molding material 426 present in annular gap 466 prior to actuation of CFR system 402 (FIG. 4A).

Relating the embodiment of CFR system 402 illustrated by FIGS. 4A to 4F to injection-molding method 300 of FIG. 3, after molding material 426 is injected, packed, etc., into mold cavity 420 and gate 424 is closed at step 315, step 320 of reducing the likelihood of crown-flash formation can be performed. For example, when CFR system 402 of FIG. 4A is designed and configured to completely separate molding material 426 in molding 422 from the molding material in annular gap 466 at planar annulus 470 prior to de-molding, as soon as the molding material in the annular gap has sufficiently cooled to provide it with the proper mechanical properties, rotation-actuation mechanism 456 is actuated so as to rotate valve stem 432, including tip portion 432A. Because of the mechanical interlock between molding material 426 and tip portion 432A, the molding material in annular gap 466 rotates with the tip portion, which in turn causes increased stresses within the molding material at planar annulus 470. Rotation-actuation mechanism 456 is suitably controlled to rotate tip portion 432A to at least the point where the stresses in molding material 426 at planar annulus 470 are so high that the molding material separates substantially along the planar annulus. After separation occurs, or at some time just before or coincidental with separation, molding 422 is de-molded at step 325, which is generally illustrated in FIG. 4F.

When a conventional reciprocating valve stem is in its closed position, the outer periphery of its tip portion is typically spaced from periphery 424A of gate 424 by a relatively small annular gap, such as 5 microns to 10 microns or less, to minimize the amount of the molding material in the space between periphery of the gate and the tip portion of the valve stem, and hence reduce the amount of crown flash that forms upon de-molding. While the same annular gaps can be used with a CFR system of the present disclosure, such as CFR system 402, the presence of a CFR system can allow for larger gaps. This is so because in some cases conventional practices for minimizing crown flash focus on minimizing the annular gap. However, making the gaps small often cause other problems, including alignment issues and excessive wear between parts, which negated benefits from making the gaps small in the first place. Intentionally larger annular gaps afforded by CFR systems of the present invention can overcome those issues.

As those skilled in the art will readily appreciate, the amount of rotation needed to effect the desired weakening/separation will vary from implementation to implementation based on a number of factors, including, but not necessarily limited to, the physical properties of the molded material at the temperature that the CFR system is designed to operate, the size and thickness of the annular gap between the tip portion of the valve stem and the periphery of the gate, the size, number, configuration, etc. of the mechanical interlock feature(s) provided. In some cases, the amount of rotation of the tip portion of the valve stem needed to effect the desired weakening/separation might be a couple of degrees of rotation, while other cases might benefit from a full revolution or more. It may also be advantageous to rotate the valve stem in both directions. In any case, determining the proper amount of rotation can be readily determined without undue experimentation.

Similarly, the maximum speed of rotation needed to properly effect the desired weakening/separation will typically vary from implementation to implementation based on a number of factors, such as, but not necessarily limited to, any one or more of the following: the physical properties of the molded material at the temperature that the CFR system is designed to operate, the size and thickness of the annular gap between the tip portion of the valve stem and the periphery of the gate, the size, number, configuration, etc. of the mechanical interlock feature(s) provided. As mentioned above, it may also be advantageous to rotate the valve stem in both directions. In any case, determining a suitable speed of rotation can be readily determined without undue experimentation.

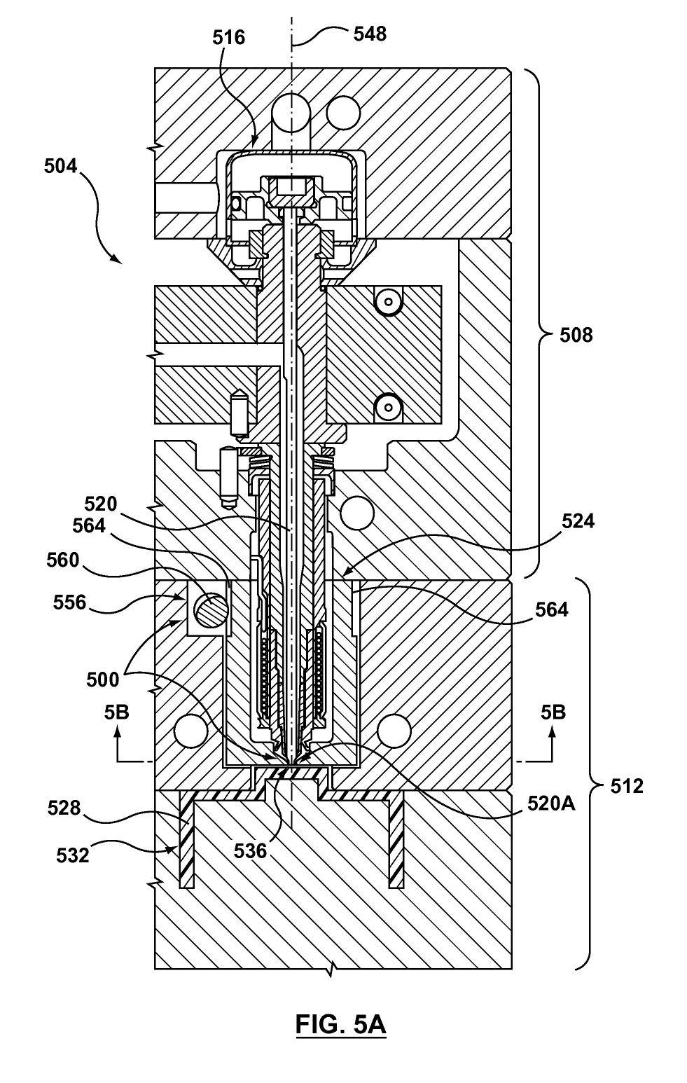

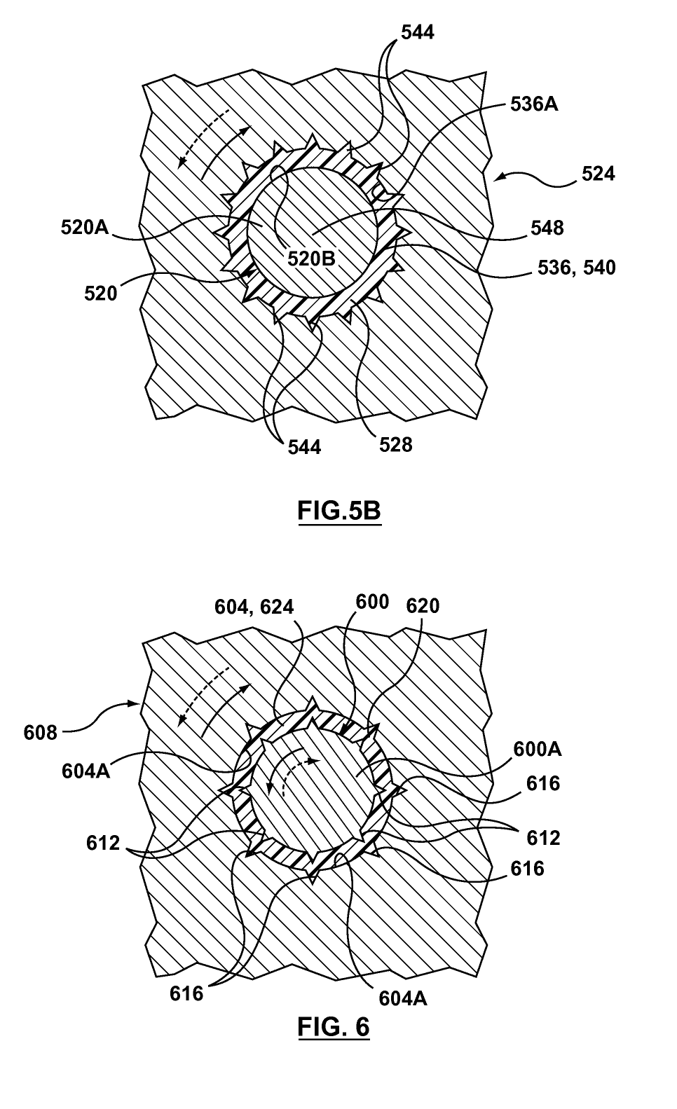

FIGS. 5A and 5B illustrate another CFR system 500 of the present invention. For convenience, as seen in FIG. 5A CFR system 500 is shown in the context of a hot runner/mold assembly 504 that is largely the same as hot runner/mold assembly 400 of FIG. 4A, except for the configuration of CFR system 500. For example, assembly 504 of FIG. 5A includes a hot runner 508, a mold 512, and reciprocating-type valve assemblies 516, only one of which is shown for ease of illustration. As described below in detail, CFR system 500 is a rotational type system generally like CFR system 402 of FIG. 4A. However, instead of valve stem 520 (FIG. 5A) being rotated during CFR operations as with CFR system 402 of FIG. 4A, mold 512 includes a movable (here, rotatable) mold gate member 524 (FIG. 5A) that is rotated during CFR operations to effect the desired weakening/separation of molding material 528 proximate molding 532.

FIG. 5B shows valve stem 520 in a closed position relative to a gate 536 formed in movable gate member 524. Relative to opening and closing gate 536, valve assembly 516 (FIG. 5) operates in the same reciprocating manner as valve assembly 414 of FIG. 4A, so for brevity FIGS. 5A and 5B only show valve stem 520 in its closed position, which is its position relevant to the operation of CFR system 500 (FIG. 5A). As seen in FIG. 5B, valve stem 520 includes a tip portion 520A that extends into gate 536 and is spaced from periphery 536A of the gate to form a generally annular gap 540. In this embodiment, the lateral surface 520B of tip portion 520A is substantially smooth and continuous and free of any mechanical-interlock features, whereas periphery 536A includes at least one interlock feature, here a plurality of grooves 544 extending in a direction parallel to the longitudinal axis 548 of valve stem 520. Similar to interlock feature(s) 468 of FIGS. 4D and 4E, grooves 544 of FIG. 5B are provided to create a sufficient mechanical interlock between molding material 528 present in annular gap 540 such that when movable gate member is rotated at an appropriate time within a molding cycle, for example, when the molding material has sufficiently cooled so that the molding material is in an appropriate physical state, such that the molding material is sufficiently weakened or separated generally at a planar annulus (not illustrated, but nearly identical to planar annulus 470 of FIG. 4D) proximate to molding 532 so that crown flash is minimized, if not eliminated, on the molding after it has been de-molded. Characteristics of grooves 544 and alternatives, as well as considerations for determining the amount and/or speed of rotation needed to effect the desired result are as described above relative to FIGS. 4A to 4F.

Referring again to FIG. 5A, in this example movable mold gate member 524 is driven by a worm-gear drive system 556 that includes a worm gear 560 that enmeshes with corresponding teeth 564 on movable mold gate member 524. Although not particularly illustrated, worm gear 560 can be driven by any suitable drive, such as an electric motor, pneumatic drive, hydraulic drive, etc., to suit a particular application. Aspects of hot runner/mold assembly 504 not described can be the same as the corresponding aspects of hot runner/mold assembly 400 of FIG. 4A. Of course, rotation-actuation mechanism 456 of FIG. 4A and its attendant parts, such as extended piston head 458, rack gear 460, and 0-ring 462, would not be needed in the embodiment of FIG. 5A.

FIG. 6 illustrates a tip portion 600A of a valve stem 600 in its closed position relative to a gate 604 formed in a rotatable gate member 608 in another CFR system made in accordance with the present invention. As readily seen in FIG. 6, each of tip portion 600A and periphery 604A of gate 604 have mechanical interlock features 612 and 616, respectively. Effectively, the CFR system of FIG. 6 can be considered a combination of the general concepts disclosed in FIGS. 4A and 5A above. In other words, in FIG. 6, each of valve stem 600 and rotatable gate member 608 are rotatable, for example, in unison with one another. With this arrangement, the molding material 620 present in the generally annular gap 624 between tip portion 600A and periphery 604A of gate 604 benefits from mechanical interlock with both sets of interlock features 612, 616 on either side of the gap. As those skilled in the art will understand, valve stem 600 and rotatable valve gate member 608 can be rotated by separate mechanisms in the same or opposing directions. Alternatively, valve stem 600 and rotatable valve gate member 608 can be designed with one or more features that allow the two to enmesh so that when one of them is actively driven the other one moves with the driven one. For example, interlock features 612, 616 themselves could be configured to enmesh with one another. Alternatively, enmeshing/inter-engaging members separate from interlock features 612, 616 could be provided to effect the unified rotation of valve stem 600 and valve gate member 608. Each drive mechanism used can be the same as the drive mechanisms described above in connection with CFR systems 400, 502 of FIGS. 4A and 5A, respectively, or could be any suitable drive mechanism, such as any of the alternatives described above.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An injection-molding system, comprising:
a mold that includes a mold cavity and a gate in fluid communication with said mold cavity, said mold designed and configured for molding a molding and said gate having a periphery;
a runner operatively configured for injecting a molding material into said mold cavity via said gate, said runner including a valve member operable to close said gate to flow of the molding material by movement of said valve member into said gate; and
a crown-flash-reduction system designed and configured to actively participate in separating molding material present in the molding from molding material present between said valve member and said periphery of said gate when said valve member is positioned in said gate.

2. An injection-molding system according to claim 1, wherein said runner includes a first actuator designed and configured to actuate said valve member in a first set of motions so as to open and close said gate, said crown-flash-reduction system including a second actuator designed and configured to actuate said valve member in a second set of motions different from said first set of motions.

3. An injection-molding system according to claim 2, wherein said valve member comprises a valve stem having a longitudinal axis and said first actuator is designed and configured to reciprocate said valve stem along said longitudinal axis, said second actuator being designed and configured to move said valve stem in a direction substantially perpendicular to said longitudinal axis.

4. An injection-molding system according to claim 3, wherein said second actuator is designed and configured to rotate said valve stem about said longitudinal axis.

5. An injection-molding system according to claim 4, wherein said valve stem has a tip region that extends into said gate when said gate is closed, said tip region including at least one interlock feature designed and configured to create a mechanical interlock between said tip region and the molding material present between said tip region and said periphery of said gate when said tip region is positioned in said gate.

6. An injection-molding system according to claim 5, wherein said tip region has a lateral surface relative to said longitudinal axis, said at least one interlock feature including surface roughening of said lateral surface.

7. An injection-molding system according to claim 5, wherein said tip region has a lateral surface relative to said longitudinal axis, said at least one interlock feature including a plurality of recesses formed in said lateral surface.

8. An injection-molding system according to claim 1, wherein said crown-flash-reduction system includes a moveable member engaged with said mold and movable relative to said mold, said movable member defining said inner periphery of said gate.

9. An injection-molding system according to claim 8, wherein said gate has a central axis parallel to flow of the molding material therethrough, and said movable member is operable so as to rotate about said central axis.

10. An injection-molding system according to claim 9, wherein said movable member includes at least one interlock feature on said inner periphery of said gate.

11. An injection-molding system according to claim 10, wherein said at least one interlock feature includes surface roughening on said inner periphery of said gate.

12. An injection-molding system according to claim 10, wherein said at least one interlock feature includes a plurality of recesses formed in said inner periphery of said gate.

13. An injection-molding system according to claim 1, further comprising a control system designed and configured to generate a crown-flash-reduction control signal for controlling said crown-flash-reduction system.

14. An injection-molding system according to claim 13, further comprising a de-molding system, said control system designed and configured to generate a de-molding control signal for controlling said de-molding system.

15. An injection-molding system according to claim 14, wherein said control system is designed and configured to generate said crown-flash-reduction signal prior to said de-molding signal.

16. An injection-molding apparatus configured for injecting a molding material into a mold cavity via a mold gate having a periphery, the injection-molding apparatus comprising:
a valve assembly comprising a valve member that is designed and configured to, during molding operations:
reciprocate in a first motion between 1) an open position in which the gate is open to flow of the molding material and 2) a closed position in which said valve member extends into the gate so as to effectively close the mold gate to the flow of the molding material; and
while said valve member is in said closed position, move in a second motion that is different from said first motion and is selected to participate in separating molding material in the mold cavity from molding material present between said valve member and the periphery of the mold gate.

17. An injection-molding apparatus according to claim 16, wherein said valve member has a longitudinal axis and said first motion is along said longitudinal axis and said second motion is in a plane substantially perpendicular to said longitudinal axis.

18. An injection-molding apparatus according to claim 17, wherein said second motion is rotational motion about said longitudinal axis.

19. An injection-molding apparatus according to claim 17, wherein said valve assembly further comprises a first actuation system designed and configured to move said valve member in a reciprocating motion along said longitudinal axis, and a second actuation system designed and configured to move said valve member in a rotational motion about said longitudinal axis.

20. An injection-molding apparatus according to claim 16, wherein said valve member has a tip portion that extends into the mold gate when the mold gate is closed, said tip portion having a lateral surface that includes at least one interlock feature designed and configured to provide a mechanical interlock between said tip portion and the molding material present between said tip portion and the inner periphery of the mold gate.

21. An injection-molding apparatus according to claim 20, wherein said at least one interlock feature comprises a plurality of recesses.

22. An injection-molding apparatus according to claim 21, wherein said plurality of recesses comprises a plurality of grooves.

23. An injection-molding apparatus according to claim 22, wherein said valve member has a longitudinal axis and each of said plurality of grooves has a longitudinal axis that extends along said longitudinal axis of said valve member.

24. A method of injection molding a molding, comprising:
injecting a molding material into a mold cavity via a gate so as to form the molding, wherein the gate has a periphery;
positioning a valve member in the gate in a manner that substantially closes the gate to flow of the molding material into the mold cavity; and
weakening or separating connection between molding material present in the molding from molding material present between the valve member and the periphery of the gate so as to limit formation of crown flash during de-molding of the molded part.

25. A method according to claim 24, wherein said weakening or separating includes moving at least one of 1) the valve member and 2) a periphery of the gate.

26. A method according to claim 25, wherein said moving includes moving only the valve member relative to the periphery of the gate.

27. A method according to claim 25, wherein said moving includes moving only the periphery of the gate relative to the valve member.

28. A method according to claim 25, wherein said moving includes moving the valve member and periphery of the gate in synchronicity with one another.
